(19) United States
(12) Patent Application Publication
(10) Pub. No.: US 2011/0082779 A1
(43) Pub. Date: Apr. 7, 2011

(54) BILLING PROFILE MANAGER

(75) Inventors: Vincent Chi Chiu Wong, Mississauga (CA); Amyn Samji, Mississauga (CA); Ian Hendry, Mississauga (CA); Rudra Maharaj, Toronto (CA); Bohdan Zabawskyj, Woodbridge (CA)

(73) Assignee: REDKNEE INC., Mississauga, ON (CA)

(21) Appl. No.: 12/677,637

(22) PCT Filed: Sep. 13, 2007
(86) PCT No.: PCT/CA2007/001604

§ 371 Date: Nov. 8, 2010

(51) Int. Cl. G06Q 30/00; G06Q 40/00; G06Q 10/00

(52) U.S. Cl. 705/34; 705/44

(57) ABSTRACT

A billing profile management system and method is provided. In an embodiment, a billing profile manager is configured to cooperate with an existing network and prepaid server. The billing profile manager is configured to modify the prepaid server and maintain a billing profile for each subscriber that is separate from the billing profile on the prepaid server and which can ultimately override the prepaid server. Additional billing functionality to an existing network and prepaid server is thereby provided.

The present specification is a National Stage Entry of PCT/CA2007/001604 filed Sep. 13, 2007, the contents of which are incorporated herein by reference.

### FIELD

The present invention relates generally to telecommunications and more particularly relates to a billing and profile management in a telecommunication system.

### BACKGROUND

With worldwide network bandwidth becoming ubiquitous, an ever-expanding range of services which are carried via those networks is emerging. Growth is not expected to slow down.

Along with those applications and services is the need to process the financial transactions related to the use of those services. Current billing and other financial related systems can be improved upon in order to appropriately support and reflect the nature of the service.

### SUMMARY

The specification provides, amongst other things, a billing profile management system comprising a network configured to a fulfill service request on behalf of a mobile device. The system also comprises a prepaid server connected to the network. The prepaid server is configured to debit a prepaid account associated for the mobile device based on fulfillment of the service request by the network. The system also comprises a billing manager connected to the network and the prepaid server. The billing manager is configured to maintain another account associated with the mobile device. The billing manager configured to update the prepaid account based on billing criteria associated with the mobile device.

The specification also provides, amongst other things, a billing profile management system comprising a network configured to fulfill a service request on behalf of a mobile device and a billing manager connected to the network. The billing manager is configured to maintain a plurality of different billing profiles associated with the mobile device. Each of the billing profiles includes at least a billing entity and a criterion for selecting the billing profile. The billing manager is configured to select an appropriate one of the billing profiles based on the service request from the mobile device and to bill the billing entity respective to the selected billing profile. The billing profile management system can further, optionally, include a prepaid server connected to the network configured to debit a prepaid account associated for the mobile device based on fulfillment of the service requests by the network. The billing profile management system can further, optionally, include an event record based billing system connected to the network configured to debit a post-paid account associated with the subscriber based on fulfillment of the service requests by the network. In this case the billing manager is configured to modify the prepaid or postpaid account according to the billing profile in order to allocate a charge associated with a service supported by the mobile device and to optionally cause the network to selectively permit or deny the service request.

### BRIEF DESCRIPTION OF THE DRAWINGS

FIG. 1 is a schematic representation of a billing profile management system.

FIG. 2 is a flowchart depicting a method for emergency top up of a prepaid account.

FIG. 3 is a flowchart depicting a method for topping up prepaid account.

FIG. 4 is a flowchart depicting a method for management of a plurality of billing profiles.

### DETAILED DESCRIPTION OF THE EMBODIMENTS

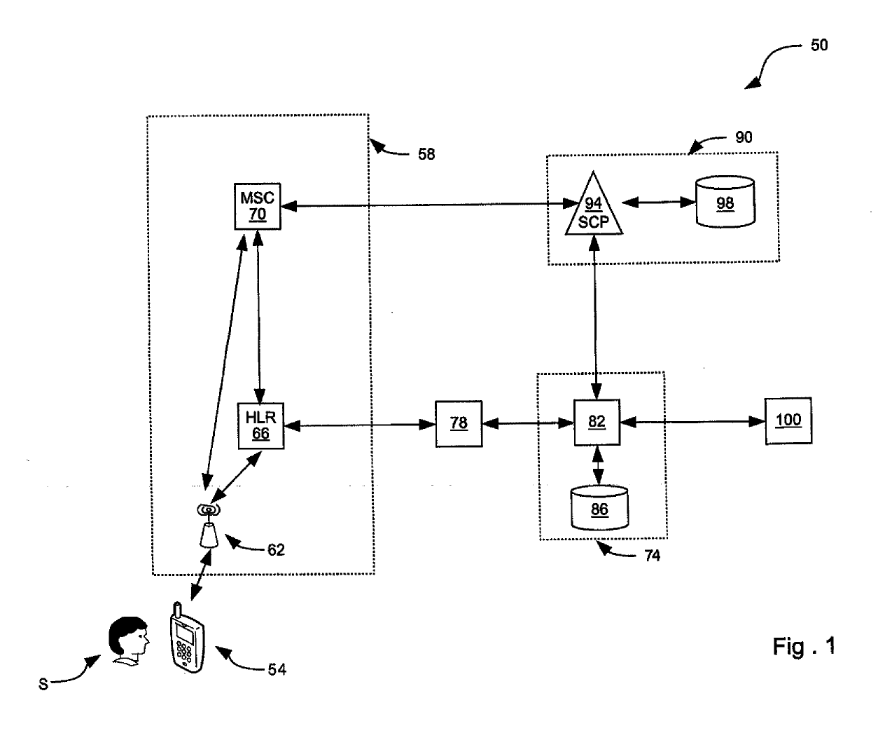

Referring now to FIG. 1, a billing profile management system is indicated generally at 50. System 50 comprises at least one mobile device 54 that is operated by a subscriber S. Mobile device 54 can be a mobile telephone or an enhanced device that includes functionality of a telephone, email pager, web-browser, music player, or video player. Depending on the functionality of device 54, device 54 is operable to access a plurality of network services such as voice, text, video, music, web-browsing, mapping, email and variations and hybrids thereof and enhancements thereto.

Mobile device 54 is associated with a home network 58 that comprises at least one wireless base station 62 connected to a home location register (HLR) 66 and a mobile switching center (MSC) 70. Subscriber S can thus access home network 58 using mobile device 54 in the usual manner. The components shown in home network 58, and their interconnection, are simplified for purposes of explanation. Those skilled in the art will recognize that network elements such as the HLR will evolve in a manner prescribed by standards and specifications put forward by organizations including, but not limited to, the 3GPP, 3GPP2, TIA, ITU, ANSI, and ETSI. For example, the HLR will evolve to provide the functionality prescribed by a Home Subscriber Server (HSS) without diluting the scope of the disclosure. Those skilled in the art will also recognize that the mobile device 54 can be connected to other network elements via a wireless base station 62 for the purpose of invoking or receiving services, including but not limited to, a SGSN (Serving GPRS Support Node), PDSN (Packet Data Serving Node), or WLAN (Wireless Local Area Network) Access Point.

System 50 also comprises a billing profile manager 74 that comprises a gateway 78 connected to a billing management engine 82 and to a billing manager database 86. Billing profile manager 74 can be operated by the same entity that operates home network 58 or can be independent as desired.

System 50 also comprises a prepaid server 90 that itself comprises a service control point (“SCP”) 94 and an account balance database 98. Prepaid server 90 implements prepaid services on behalf of prepaid subscribers to home network 58 in the usual manner, such that subscribers can make prepaid calls via network 58. In general, the functionality of SCP 94 and account balance database 98 will now be readily understood by those skilled in the art. Prepaid server 90 can be operated by the same entity that operates home network 58 or can be independent as desired.

As will be discussed further below, billing profile manager 74 is generally configured to provide a plurality of flexible billing options and methodologies for the operator of network 58. In certain embodiments, such flexible billing options and methodologies are implemented without requiring material modification to existing infrastructure within network 58 and/or server 90.

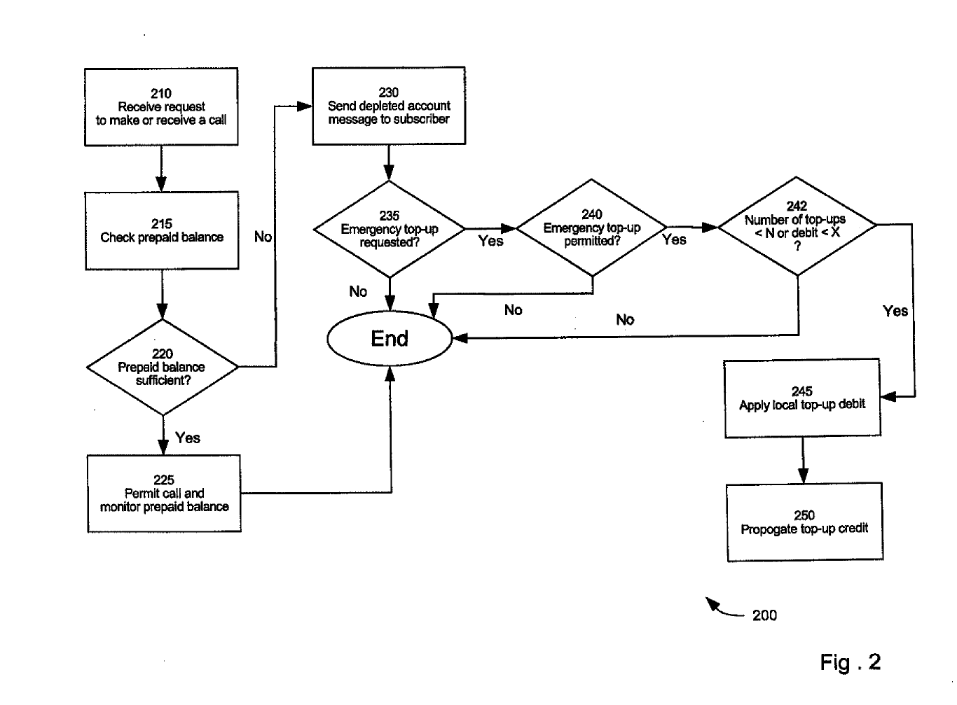

In one embodiment, where subscriber S is a prepaid subscriber on network 58, then system 50 can be used to permit subscriber S to make emergency top-ups to the prepaid balance associated with the prepaid account used by subscriber S and that is maintained by prepaid server 90. Referring now to FIG. 2, a method for emergency top-up is depicted in the form of a flow-chart and is indicated generally at 200. Method 200 can be performed using system 50, though it should be understood that variations to both system 50 and method 200 are contemplated.

As previously discussed, method 200 assumes that subscriber S is a prepaid subscriber on network 58, and that the account balance for subscriber S is maintained on prepaid server 90 in the usual manner. Beginning first at step 210, a request is received to make a call from a mobile device or to receive a call at a mobile device. (Note that while the request is for a call this embodiment, in other embodiments the request can be to invoke or receive any service that is available from device 54 and supported by network 58). In relation to system 50, such a request is made by subscriber S using device 54 to dial a number, and is received by HLR 66 and MSC 70 in the usual manner. At step 215 MSC 70 checks prepaid server 90 to ascertain the prepaid balance associated with subscriber S. At step 220, if it is determined that the subscriber's prepaid balance is sufficient, then method 200 advances to step 225 where the prepaid call is processed and monitored in the usual manner.

However, if at step 220 it is determined that the prepaid balance is not sufficient then method 200 advances from step 220 to step 230 and a message (for example, via short message service (“SMS”)) is sent to device 54 indicating that the account is depleted. A typical criterion for insufficient balance would include a prepaid account with a balance equaling zero, but a balance greater than zero could also be set as the criterion, where such a balance is beyond some minimal amount needed to complete the call request made at step 210. Those skilled in the art will recognize that there are a variety of means and mechanisms whereby a ‘low balance’ indication can be provided to the subscriber S via the mobile device 54 including, but not limited to, voice-based announcements provided by Intelligent Network (IN) elements such as Intelligent Peripheral (IP) devices and tones provided by the MSC 70.

Next, the method 200 advances to step 235, at which point a determination is made as to whether subscriber S requests an emergency top-up. In a present embodiment, it is contemplated that gateway 78 is an Unstructured Supplementary Service Data (“USSD”) gateway configured to receive USSD codes entered into device 54 by subscriber S, and which are automatically routed from HLR 66 to USSD gateway 78. Thus, subscriber S will have been previously informed of a predefined-USSD code (e.g. *999#) that represents a request for an emergency top up of the prepaid account associated with subscriber S in prepaid server 90. If subscriber S does not enter the predefined-USSD code at step 235 then method 200 ends. However, if subscriber S does enter the predefined-USSD code at step 235, then method 200 advances from step 235 to step 240.

Next, at step 240, a determination is made as to whether subscriber S is permitted to make an emergency top-up to the prepaid account associated with subscriber S. Such a determination can be based on a subscription profile associated with subscriber S and assessable via the billing profile manager 74. Those skilled in the art will recognize that the subscription profile may be stored in a variety of network elements including the HLR 60 or another database or data warehouse resident in the network operator's operational support system (OSS) or Business Support System (BSS). The subscriber profile associated with subscriber S may also be accessed via a profile server implemented according to the teachings of U.S. patent application Ser. No. 11/516,308 entitled Method And System For Active Profile Server filed Sep. 6, 2006, the contents of which are incorporated herein by reference. If the determination at step 240 is “no” then method 200 ends. If the determination at step 240 is “yes”, then the method proceeds to step 242.

At step 242, the method determines the number of serial emergency top-ups that have been applied or if the accumulated top-up debit stored in the billing manager is less than a given threshold. For example, if the serial emergency top-up counter is set to three, a given subscriber S would be permitted to apply two emergency top-up pursuant to the method 200. As another example, if the accumulated emergency top-up debit threshold is set to $11.00, a given subscriber S would be permitted to apply an emergency top-up only if the top-up debit is less than $11.00. If the determination at step 242 is “no” then method 200 ends. If the determination at step 242 is “yes”, then the method proceeds to step 245. In an optional manifestation of the method, a message indicating why the emergency top-up request was not accepted may be sent to the subscriber (e.g. via SMS).

At step 245, in response to the USSD code, a top-up debit is applied. At step 245, gateway 78 will have passed the top-up request and an identity of subscriber S along to billing management engine 82, which will access billing manager database 86 and record that subscriber S has requested an emergency top-up and will debit an account maintained on billing manager database 86 that reflects a predefined emergency top-up amount. The predefined amount is not particularly limited, and can be based on simple increments that correspond to amounts associated with prepaid cards that are issued by network 58, and/or can be an amount that is specifically requested according to the request (e.g. the USSD request) made at step 240. For example, the predefine USSD code could include a field whereby the subscriber S indicates an amount for the emergency top-up. For example, *999#5, would represent a request for an emergency top up of five dollars.

Next, at step 250, the top-up credit will be propagated to the appropriate entity in the system. In system 50, engine 82 will send an instruction to prepaid server 90 indicating that the prepaid account associated with subscriber S has been credited an amount equivalent to the predefined amount discussed earlier.

At this point, after performance of step 250, system 50 can be configured so that method 200 ends and now subscriber S can initiate or receive a new call, or, system 50 can be configured so that method 200 returns from step 250 to step 215 whereby system 50 will assume that subscriber S is still attempting to make a call in accordance with the original request received at step 210.

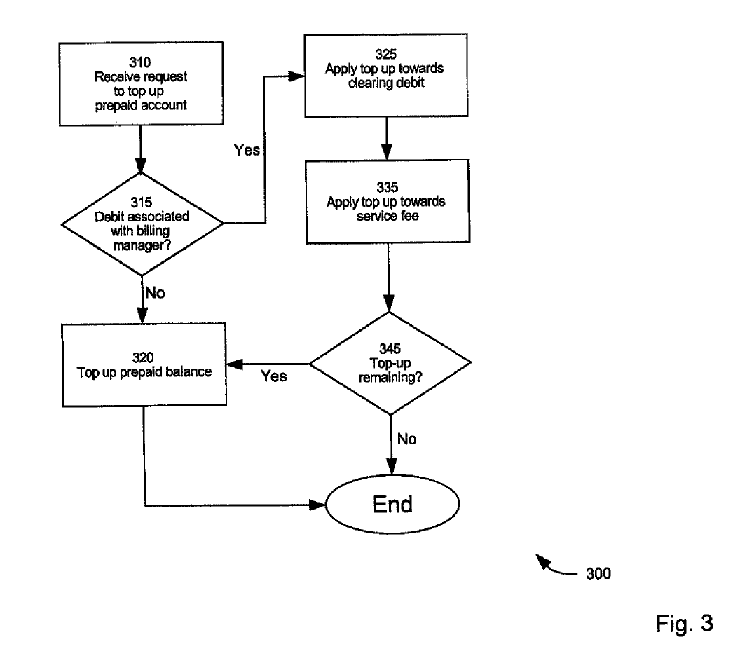

Referring now to FIG. 3, a method for topping up a prepaid account is depicted in the form of a flow-chart and indicated generally at 300. Method 300 can be performed using system 50, though it should be understood that variations to both system 50 and method 300 are contemplated. Method 300 is particularly applicable once method 200 has been performed.

Beginning at step 310, a request is received to top-up a prepaid account. This request can be effected in the usual manner—for example, subscriber S purchases a prepaid card for a predefined amount and uses device 54 to enter in an appropriate sequence of digits unique to the prepaid card which amount to a set of instructions to add the predefined amount to the prepaid account associated with subscriber S. (Of course, other methods for making a top-up request are also contemplated, including via an Internet website, an interactive voice response (“IVR”) prompt system, etc.)

Next at step 315, a determination is made as to whether there is any outstanding debit associated with subscriber S. For example, assume that during previous performance of step 200 for subscriber S that the method ended directly after step 235, determining that no emergency top up was permitted. In this example, the determination at step 315 would be “no” and method 300 would advance from step 315 to step 320 and the prepaid account for subscriber S would be topped up at prepaid server 90 with an amount that directly corresponded to the predefined amount on the prepaid wireless card referenced in relation to step 310.

Referring again to step 315, however, assume as another example that subscriber S had previously been permitted to invoke steps 240-250 of method 200, in which case a debit amount as set at 245 would be associated with subscriber S. In this example, a “yes” determination would be reached at step 315 and method 300 would advance from step 315 to step 325.

At step 325, the top up amount from step 310 is first applied to clearing any accumulated debit that was generated previously at step 245 of method 200. Thus, for example, if the debit from step 245 was for five dollars, and the predefined amount from step 310 was for twenty dollars, then the predefined amount from step 310 would be reduced to fifteen dollars. At this point in time the serial emergency top-up counter will also be reset to zero. Next, at step 335 (which is an optional step) a service fee amount is applied from the remaining top up predefined amount. Thus, if the service fee amount was one dollar, then the predefined amount from step 310, and as adjusted at step 325, would be further reduced from fifteen dollars by one dollar to fourteen dollars.

Next, at step 345, a determination is made if there is any top-up amount remaining. If there is no amount remaining (e.g. all amounts from step 310 were consumed by step 325 and/or step 335) then the determination at step 345 is “no” and method 300 ends. If the determination at step 345 is “yes”, then method 300 advances from step 345 to step 320 and any remaining top up balance is applied in the usual manner. In the above example, where fourteen dollars was remaining, then the prepaid account belonging to subscriber S in server 90 would be topped up by fourteen dollars only, instead of the full twenty dollars associated with the prepaid card referenced above in relation to step 310.

It should be understood that methods 200 and 300 can be readily modified for use in a roaming configuration and methods 200 and 300 can operate substantially as described above.

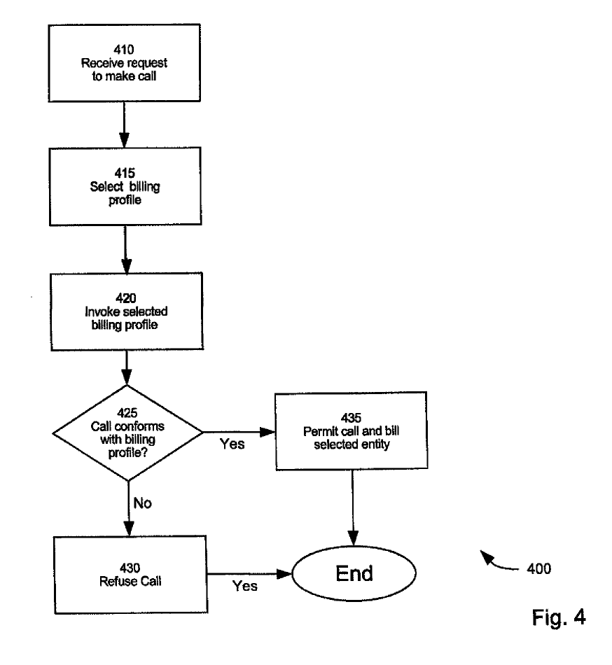

Methods 200 and 300 only reflect one possible implementation for system 50. In another embodiment, subscriber S can be associated with a plurality of different billing profiles such that different billing profiles are selected and invoked based on a flexible range of criteria. An example of this embodiment is presented in FIG. 4 as method 400. While method 400 can be implemented on system 50, it should again be understood that method 400 can be implemented on other network configurations other than system 50.

Beginning at step 410, a request is received to make or receive a call (or to invoke any other type service supported by device 54 and network 58). Again, using system 50, step 410 is effected in much the same manner as step 410 described above. Next, at step 415 a billing profile is selected. Step 415 is effected by billing profile manager 74. In this embodiment, gateway 78 is generally configured to intercept or otherwise be notified of a call request initiated from or received at a mobile device 54 that participates in the multiple billing profile service associated with method 400 prior to call completion. Those skilled in the art will recognize that gateway 78 can intercept or otherwise be notified of a call request via a number of mechanism, including but not limited to, Intelligent Network based mechanisms including those prescribed by 3GPP, 3GPP2, ANSI, ITU, ETSI, and TIA, session-notification mechanisms via SIP, RADIUS or DIAMETER (for example the ISC (IMS Service Control), Ro, Rx, Gx, and Gy interfaces prescribed by the 3GPP and 3GPP2), as well as Application Programming Interface based mechanisms as prescribed by industry bodies such as the Open Mobile Alliance, Parlay, and the Java Community Process. (Gateway 78 need not participate in any calls that do not involve the multiple billing profile service.)

Billing manager database 86 is configured to maintain a plurality of billing profiles associated with subscriber S, and engine 82 is configured to select one of those billing profiles based on predefined criteria. Alternatively, billing manager database 86 can retrieve the relevant billing profile attributes via a profile server implemented according to the teachings of U.S. patent application Ser. No. 11/516,308 entitled Method And System For Active Profile Server filed Sep. 6, 2006, the contents of which are incorporated herein by reference. The structure and content of billing profiles and criteria are not particularly confined. However, Table I shows an example set of billing profiles.

TABLE I
Exemplary Billing Profiles

| Billing | | | | | |
|---|---|---|---|---|---|
| Profile | Billing Entity | Criterion 1 | Criterion 2 | Criterion 3 | Account |
| 1 | X Corporation | Time of day is | Telephony | Calls within | Postpaid |
| | | between 9 AM | service only | North America | Account |
| | | and | | only | Identifier X1 |
| | | 5 PM Monday | | | |
| | | through Friday | | | |
| 2 | Subscriber S | Time of day | Telephony | Empty | Postpaid |
| | | does not equal | service only | | Account |
| | | Criterion 1 | | | Identifier S1 |
| 3 | Subscriber S | Time of day | Data | Empty | Prepaid |
| | | does not equal | services | | Account |
| | | Criterion 1 | except | | Identifier S2 |
| | | | Mobile TV | | |
| 4 | Subscriber S | Time of day | Mobile TV | Empty | Postpaid |
| | | does not equal | | | Account |
| | | Criterion 1 | | | Identifier |
| | | | | | Sponsor_1 |

Table I can be useful in a situation where a subscriber S uses device 54 for both work and personal purposes. For work uses, billing profile 1 is invoked and X Corporation (the employer of subscriber S) is billed directly. For personal uses, billing profiles 2, 3, and 4 are invoked and subscriber S is billed directly. X Corporation is billed for all telephone calls within North America that are made between 9 AM and 5 PM Monday through Friday. Applicable charges for services used in connection with X Corporation are directed to a postpaid account as identified via Account Identifier X1. All other types of calls and services are not permitted. The Subscriber S is billed for all calls or other services that are made during any of the times that are not made between 9 AM and 5 PM Monday through Friday. Applicable charges for voice-based calls made by Subscriber S in these timeframes are directed to a postpaid account as identified via Account Identifier S1. Applicable charges for data services except Mobile TV made by Subscriber S in these timeframes are directed to a prepaid account as identified via Account Identifier S2. Applicable charges for Mobile TV services made by Subscriber S in these timeframes are directed to a post-paid account as identified via Account Identifier Sponsor 1. Note that the last entry may be used to identify a sponsored or promotional service offering.

Thus, assuming that step 415 is being performed using Table I, then the criteria in Table I would be used to select an appropriate billing profile and associated billing entity. Thus, if the call at step 410 was initiated at 9:30 AM on a Tuesday morning, then Billing Profile 1 would be selected. However, if the call at step 410 was initiated on the weekend, then Billing Profile 2, 3, or 4 would be selected.

Next, at step 420, the selected billing profile is invoked. In the example associated with system 50, depending on whether the Billing Profile indicated that the service was associated with a prepaid or postpaid account, billing engine 82 will generate call detail records (or the like) relative to any calls that are made and completed according to method 400. These call detail records can be used by an event record based billing system 100 connected to the network configured to debit an account associated with the subscriber. In the present exemplary embodiment, billing engine 82 may also be configured to modify the account according to said billing profile in order to cause the network 58 to selectively permit or deny said service request. For example, the billing engine 82 may access prepaid server 90 to provide a balance and to establish any calling restrictions in prepaid server 94 that are consistent with the selected billing profile. In the present exemplary embodiment, billing engine 82 may also make subscriber S and device 54 appear to be a prepaid subscriber for which calls are completed and managed in the usual manner. To the extent that an account does not exist in the prepaid server 94 or event record based billing system 100, the billing profile manager 74 may create and maintain a virtual account with applicable calling restrictions in the billing manager database 86 or in the prepaid server 94. To the extent that the service logic in the prepaid server 94 or event record based billing system 100 cannot accommodate for any configured criteria, the billing profile manager 74 may be optionally configured to execute the applicable service logic and only debit the prescribed account. In this manner, network 58, the event record based billing system, and prepaid server 90 need not be substantially modified, and likewise, subscriber S can roam—while at the same time allowing different billing profiles to actually be effected for the one subscriber S and device 54.

Thus, at step 425, a determination is made as to whether the call requested at step 410 conforms with the billing profile. In general, call processing logic will verify that the requested call will comply with all of the criteria in the selected billing profile. For example, if billing profile 1 was selected then Criterion 2 and Criterion 3 must also be complied with in order for any call to be completed. Thus, at step 425, in this example, only a call from step 410 that is within North America would be permitted—a SMS would not be permitted, or a call outside North America would not be permitted.

If the call is not permitted then method 400 advances from step 425 to 430 and the call is refused. If the call is permitted then method 400 advances from step 425 to 435 and the call is permitted and billing entries for the appropriate billing entity are updated. Step 435 can be effected in part by network 58 and billing profile manager 74 in conjunction with prepaid server 90 working together to complete the call and to decrement a prepaid balance stored on server 90 accordingly. The remainder of step 435 is effected by billing engine 82, which examines the remaining prepaid balance on server 90 at the termination of the call (or periodically throughout the call, if needed). Alternatively, step 435 can be effected in part by network 58 and billing profile manager 74 in conjunction with event record based billing system 100 via the generation and processing of call detail records.

The previous discussion of method 400 was simplified for ease of explanation. It should be understood that billing profiles can be much more complex than the billing profiles in Table I. Other billing profiles can include: whether or not a billing entity is billed on a prepaid or post-paid basis, or hybrids thereof; various types of services that can be billed on the profile and indeed different profiles can be invoked depending on the type of service that is requested at step 410.

It should now be understood that the foregoing present certain exemplary embodiments, but modifications, variations, subsets and/or combinations thereof are contemplated. For example, it should be understood that method 400 can be implemented on a version of system 50 that does not include prepaid server 90 or event record based billing system 100.

1. A billing profile management system comprising:
a network configured to a fulfill service request on behalf of a mobile device;
a prepaid server connected to said network configured to debit a prepaid account associated for said mobile device based on fulfillment of said service request by said network; and
a billing manager connected to said network and said prepaid server configured to maintain another account associated with said mobile device; said billing manager configured to update said prepaid account based on billing criteria associated with said mobile device.

2. The billing profile management system of claim 1 wherein said billing manager is configured to update said prepaid server to reflect a positive balance in said prepaid account while maintaining a corresponding debit balance in said another account.

3. The billing profile management system of claim 2 wherein said billing manager is configured to perform said update based on a request from said mobile device.

4. The billing profile management system of claim 3 wherein said billing manager includes a message gateway and said request is a predefined string.

5. The billing profile management system of claim 4 wherein the message gateway is a USSD (Unstructured Supplementary Service Data) gateway and said request is a predefined USSD string.

6. A billing profile management system comprising:
a network configured to fulfill a service request on behalf of a mobile device;
a billing manager connected to said network; said billing manager configured to maintain a plurality of different billing profiles associated with said mobile device; each said billing profile including at least a billing entity and a criterion for selecting said billing profile;
said billing manager configured to select an appropriate one of said billing profiles based on said service request from said mobile device and to bill said billing entity respective to said selected billing profile.

7. The system of claim 5 further comprising a billing system connected to said network configured to debit an account associated for said mobile device based on fulfillment of said service requests by said network; said billing manager configured to modify said account according to said billing profile in order to cause said network to selectively permit or deny said service request.

8. The system of claim 7 wherein the billing system is a prepaid server or an event record based billing system.

9. A method for emergency top-up of a subscriber balance associated with a mobile device; said subscriber balance optionally applicable to a service that can be performed on said mobile device; said method comprising:
receiving a request for emergency top-up of said subscriber balance;
determining if said request is permitted;
debiting an account associated with said subscriber.
performing said top up if said request is permitted.

10. The method of claim 9 further comprising, prior to said receiving:
receiving a request to fulfill a service on behalf of a mobile device associated with said subscriber;
examining said subscriber balance associated with said mobile device;
if said balance is sufficient then fulfilling said service; and
if said balance is insufficient sending a notification to said subscriber.

11. The method of claim 9 wherein said request is in the form of a Unstructured Supplementary Service Data (USSD) string.

12. The method of claim 9 wherein said request is received from said mobile device.

13. The method of claim 9 wherein said determining comprises whether a profile associated with said subscriber balance permits emergency top-up.

14. The method of claim 9 wherein said determining comprises determining a total number of ones of said requests that are permitted and whether said total number has been reached or exceeded.

15. The method of claim 9 wherein said subscriber balance is associated with a prepaid account.

16. The method of claim 15 further comprising:
receiving a request top up said subscriber prepaid account including a top-up amount;
determining a debit amount associated with said account;
applying at least a portion of said top-up amount to said debit amount in order to reduce said debit amount; and,
applying any remaining portion of said top-up amount to said prepaid account.

17. A method for emergency top-up of a pre-paid account associated with a mobile device; said subscriber balance optionally applicable to a service that can be performed on said mobile device; said method comprising:
receiving a request from said mobile device for emergency top-up of said pre-paid account;
determining whether a profile associated with said pre-paid account permits emergency top-up;
determining a total number of ones of said requests that are permitted and whether said total number has been reached or exceeded;
if said request is permitted according to said determining steps then:
performing said top-up to said pre-paid account;
applying a debit amount corresponding to at least said top-up amount to a subscriber account separate from said pre-paid account.

18. The method of claim 17 wherein said debit amount includes said top-up amount and a service fee.

19. A method of billing profile management comprising:
receiving a request to fulfill a service on behalf of a mobile device associated with a subscriber;
selecting one of a plurality of billing profiles associated with said subscriber; said selecting based on criteria associated with said subscriber; and,
permitting or denying said request based on whether said service conforms with said selected billing profile.
